(19) United States
(12) Patent Application Publication
(10) Pub. No.: US 2012/0067720 A1
(43) Pub. Date: Mar. 22, 2012

(54) FILTER DEVICE FOR PURIFYING FLUIDS

(76) Inventors: Richard Eberle, Ormesheim (DE); Markus Dewes, Oberthal (DE)

(21) Appl. No.: 13/138,959

(22) PCT Filed: Apr. 22, 2010
(86) PCT No.: PCT/EP2010/002464

§ 371 Date: Nov. 22, 2011

(30) Foreign Application Priority Data
May 2, 2009 (DE) 10 2009 019 744.3

(51) Int. Cl. C10G 27/00; B01J 19/00; B01J 19/08; C25B 9/06

(52) U.S. Cl. 204/276; 422/187; 422/186

(57) ABSTRACT

The invention relates to a filter device for purifying fluids, especially fuels, that are contaminated with organic substances. Said filter device is characterised in that hydroxyl radicals are formed from water molecules contained in the fluids, by means of a separating device (10, 14, 22), said hydroxyl radicals oxidising the impurities, especially organic substances, as much as possible, and converting them into compounds such as CO₂.

The invention relates to a filter device for purifying fluids, in particular fuels, which are contaminated with organic matter.

In order to ensure the operational reliability of drive units which are to be supplied with liquid fuels, such as internal combustion engines in particular, purification of the fuels is essential. In particular, to protect the sensitive injection system against damage, organic substances and particles, which remain within the pertinent filter device as fouling, must be separated by assigned filter arrangements from diesel fuels which, in addition to entrained portions of water, are often also contaminated with organic substances and particles.

The replacement intervals of filter arrangements generally depend on the flow resistance produced by the pertinent filter arrangement. As fouling of the filter increases, the differential pressure generated across the filter medium and consequently the flow resistance increase.

With respect to these problems, the object of the invention is to make available a filter device for the purification of fluids, especially of fuels, which, although it is simple and economical to operate, enables long service lives of the pertinent filter media of the filter device.

According to the invention, this object is achieved by a filter device having the features specified in claim 1 in its entirety.

Accordingly, an important particularity of the invention resides in the fact that there is a separating means which separates the water molecules contained in the pertinent fluid, especially the fuel, such that hydroxyl radicals are formed. Since hydroxyl radicals are chemically highly reactive oxidants, organic substances are for the most part oxidized by contact with hydroxyl radicals.

While organic substances in particle form cause a high flow resistance in filter devices, this is not the case in the oxides formed by oxidation, for example CO₂. This phenomenon is known, for example, with respect to soot particle filters in the exhaust line of internal combustion engines. Here oxidation to ash is initiated by regeneration of the filter, generally by supplying heat, in order to reduce these particles to ash and CO₂. Similarly, in fluid filter devices, the invention calls for “cold” oxidation by means of hydroxyl radicals. As a result, a purification device is devised which is characterized by economical operating behavior, especially with respect to the reduction of filter changing intervals.

With respect to producing the hydroxyl radicals, the arrangement is preferably made such that the separating means has media which act as a catalyst and which form hydroxyl radicals, and/or an electrolysis apparatus.

In catalytically operating separating means, there is titanium dioxide, which is used with particular advantage as a catalyst on or in the filter medium of a filter element belonging to the filter device.

The arrangement can be advantageously made such that titanium dioxide is applied as a layer to the filter medium.

The effectiveness of the catalyst can be easily and advantageously enhanced by the arrangement being made such that the catalyst can be exposed to light radiation, especially in the wavelength range from 180 to 300 nm.

In this respect, it is possible to proceed such that the filter device has a housing part which forms a window for radiation entry of natural light or light produced by an artificial radiation source to the catalyst on the filter medium.

Alternatively, in a housing part of the filter device, which part is sealed radiation tight, there can be a radiation source within the housing part.

In an electrolytically operating separating means, the arrangement can be made such that the electrolysis apparatus has at least one diamond electrode which acts as anode in the electrolysis within a housing part which accommodates a filter element.

In advantageous exemplary embodiments, the diamond electrode can be formed on an end cap of the filter element.

To complete the electrolysis apparatus, there can be electrically conductive components of the filter medium which are formed in particular from high-grade steel or components of other parts of the filter element as cathode of the electrolysis apparatus.

With respect to making contact with the electrodes which act as anode and cathode, the art shown in document DE 10 2004 005 202 A1 can be used for connection of a DC voltage source effecting electrolysis.

The invention is detailed below using exemplary embodiments shown in the drawings.

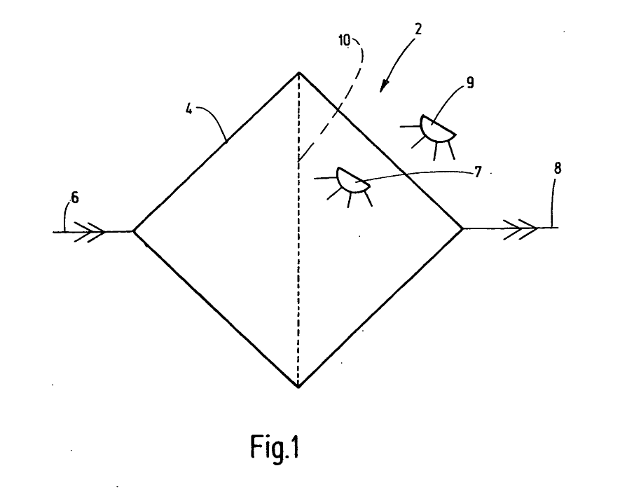

FIG. 1 shows in a schematic and simplified representation, as a symbolic sketch only, an exemplary embodiment of the device according to the invention with a catalytically operating separating means, two possible alternatives of the supply of light radiation being indicated, and

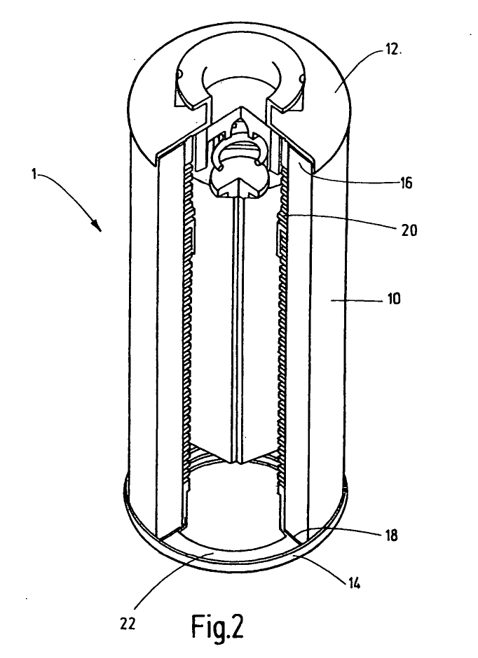

FIG. 2 shows a partially cutaway perspective view of a filter element for one exemplary embodiment of the invention in which there is an electrolytic separating means.

While in the electrolysis of water the latter is conventionally split into hydrogen and oxygen, by means of special electrodes, for example, by means of a diamond electrode which acts as anode and which is electrically conductive due to doping with the element boron, a special water decomposition can be achieved in which highly reactive hydroxyl radicals are formed instead of oxygen and hydrogen. Instead of the separation by an electrolysis apparatus, hydroxyl radicals can, however, also be produced by means of a catalyst which is in contact with the entrained water molecules, for which titanium dioxide is very well suited. Using FIG. 1, the invention is explained using one example in which the water molecules are separated by the catalyst formed by titanium dioxide.

In this context, in FIG. 1 a filter device indicated only by a symbol is designated as a whole as 2. A fuel feed line 6 and a fuel drain line 8 are connected to its housing 4. In the housing 4, there is a filter medium 10. To separate the water into hydrogen and hydroxyl radicals, the filter medium 10 is provided with a layer of titanium dioxide which acts as catalyst.

In order to enhance the catalytic action of the titanium dioxide located in the filter housing 4 and the formation of the hydroxyl radicals, there is a supply of electromagnetic radiation, in this case in a wavelength range from 180 to 300 nm. FIG. 1 shows two possible alternatives of the radiation supply. In one case, there is a light source 7 within the filter housing 4. Although only one light source 7 is shown in the drawings, there can be several light sources in suitable arrangement and of any design, for example, one or more LEDs.

In the alternative embodiment, on the filter housing 4, there is a radiation transmitting wall part which forms a preferably UV-transmitting window through which the titanium dioxide can be irradiated by means of an external light source 9. This external light source 9 can be formed by natural light or, as for the internal light source 7, by one lamp or several lamps of any design as well as radiating bodies of any type, preferably, likewise by LEDs.

By oxidation of organic fouling, “cold” oxidation prevents an overly rapid buildup of the flow resistance of the filter device 2 by rising differential pressure on the filter medium 10 so that the filter service life is extended.

In the exemplary embodiment of FIG. 2, the separating means operates electrolytically. The filter element 1 shown in FIG. 2 has a filter medium 10 which extends between two end caps 12, 14 which are each connected to an assignable end region 16, 18 of the filter medium 10, between the end region 16 and the end cap 12 there being an adhesive bed 26 which forms a type of insulating layer, whereas the other end region 18 of the filter medium 10 is permeable to fluids toward the inside of the lower end cap 14. The filter medium 10 is supported on the inner peripheral side on a support pipe 20.

The lower end cap 14 on its inside forms a diamond electrode 22 which acts as anode in operation. Said diamond electrode is a crystalline diamond layer of only few nanometers thickness on the electrically conductive end cap 14, the diamond being rendered electrically conductive by doping with the element boron. The electrochemical behavior of the diamond electrode 22 during electrolysis with an electrode which acts as cathode, especially one made of high-grade steel, leads to a separation of water molecules such that highly reactive hydroxyl radicals are formed instead of hydrogen and oxygen.

With respect to the formation of the electrode which acts as anode, there can be, for example, a high-grade steel lattice layer within the filter medium 10 which is built up in several layers as a filter mat.

With respect to making contact, the art known from DE 10 2004 005 202 A1 can be used, as already mentioned, in which several types of construction for contact-making means on filter elements are disclosed and which can be adapted to the circumstances in the operation of an electrolysis apparatus.

Regardless of whether a catalytic separation of water molecules or an electrolysis is carried out to separate water molecules into highly reactive hydroxyl radicals and hydrogen, oxidation of organic substances to the greatest extent possible takes place by contact with hydroxyl radicals. This leads, so to speak, to “cold ashing” of organic particles with escape of CO₂ and minor amounts of remaining ash residues, which do not cause any significant rise of flow resistance when they remain on the filter medium.

1. A filter device for purifying fluids, in particular fuels, which are contaminated with organic matter, characterized in that a separating means (10, 14, 22) forms hydroxyl radicals from water molecules contained in the fluids, said hydroxyl radicals oxidizing the impurities, especially organic matter, as much as possible and converting them into compounds such as CO2.

2. The filter device according to claim 1, characterized in that the separating means has hydroxyl radical-forming media (10) which act as catalyst and/or an electrolysis apparatus (10, 14, 22).

3. The filter device according to claim 2, characterized in that there is titanium dioxide which is used as catalyst on or in the filter medium (10) of a filter element (1) which belongs to the filter device.

4. The filter device according to claim 3, characterized in that titanium dioxide is applied as a layer to the filter medium (10).

5. The filter device according to claim 3, characterized in that the catalyst can be exposed to light radiation, especially in the wavelength range from 180 to 300 nm, to enhance its effectiveness as a generator of hydroxyl radicals.

6. The filter device according to claim 5, characterized in that it has a housing part (4) which forms a window for radiation entry of natural light or light produced by an artificial radiation source (9) to the catalyst on the filter medium (10).

7. The filter device according to claim 5, characterized in that there is a radiation source (7) within the housing part (4).

8. The filter device according to claim 2, characterized in that the electrolysis apparatus has at least one diamond electrode (22) which acts as anode during the electrolysis within a housing part (4) which accommodates a filter element (1).

9. The filter device according to claim 8, characterized in that the diamond electrode (22) is formed on one end cap (14) of the filter element (2).

10. The filter device according to claim 8, characterized in that there are electrically conductive components of the filter medium (10) of the filter element (1) which are formed in particular from high-grade steel as cathode of the electrolysis apparatus.
